(19) United States
(12) Patent Application Publication
(10) Pub. No.: US 2025/0066592 A1
(43) Pub. Date: Feb. 27, 2025

(54) POLYETHYLENE COMPOSITION

(71) Applicant: SABIC GLOBAL TECHNOLOGIES B.V., Bergen op Zoom (NL)

(72) Inventors: Kankan BHAUMIK, Bangalore (IN); Karel WILSENS, Veldhoven (NL); Ganesh KANNAN, Sugar Land, TX (US)

(21) Appl. No.: 18/718,832

(22) PCT Filed: Dec. 2, 2022
(86) PCT No.: PCT/EP2022/084269

§ 371 Date: Jun. 12, 2024

(30) Foreign Application Priority Data
Dec. 17, 2021 (EP) 21215682.2

(51) Int. Cl. C08L 23/06; C08K 5/053; C08L 23/08

(52) U.S. Cl. CPC C08L 23/06; C08K 5/053; C08L 23/08; C08L 2201/08; C08L 2207/062; C08L 2207/20

(57) ABSTRACT

A polyethylene composition includes at least one of (a) a first ethylene-based polymer and (b) a second ethylene-based polymer; and (c) ≥100 and ≤5000 ppm, preferably ≥500 and ≤2500 ppm, of 2,2-bis(hydroxymethyl)-1,2-propanediol, with regard to the total weight of the polyethylene composition. Such composition allows for providing a high oxidation induction temperature in combination with suppressed occurrence of yellowing of a polyethylene, in particular where a post-consumer recycle polyethylene is used in the composition.

### CROSS REFERENCE TO RELATED APPLICATIONS

This application is a National Stage application of PCT/EP2022/084269, filed Dec. 2, 2022, which claims the benefit of European Application No. 21215682.2, filed Dec. 17, 2021, both of which are incorporated by reference in their entirety herein.

### BACKGROUND

The present invention relates to a polyethylene composition. In particular, the invention

relates to a polyethylene composition comprising a fraction of post-consumer recycled polyethylene wherein the discolouration of the polyethylene and the molecular degradation is mitigated.

Polymer materials are presently ubiquitously used in a wide variety of applications,

including in durable and single-use goods, in rigid and flexible applications. To ensure that such polymer materials are equipped for a service life that is typical for its application, it needs to be safeguarded that the polymer chains in the materials are sufficiently inert vis-à-vis circumstances to which the materials are subjected during their service life. In certain situations, polymer materials may exhibit certain reactivity as a result of external circumstances that may lead to reduction or loss of properties of the materials that are required for its function in the particular application. Accordingly, a polymer materials needs to be equipped to deal with such circumstances.

Presently, the term service life may be considered to be subject to extended interpretation. Where typically the service life would encompass the cycle that originates from the production of the polymer material and/or its formulation, further including a process of shaping, incorporation in a product such as a consumer or industrial product, the use by consumers or industry, and the discard of such product as waste, increasingly there is now emphasis on extending the service life of the polymer by recycling. Such recycling may involve the re-use of the polymer material by converting a batch of matter comprising the polymer material via a recycling process that may involve compiling a suitable material formulation and/or applying the material to a shaping process to create a new product that again may find its way to e.g. consumers.

In order for the polymer material to withstand this extended service life, and to ensure that is does so whilst complying to the material requirements set for use in whatever product application the material may end up in, it is required that the reactivity of the polymer material under circumstances of environment, use and processing that it is subject to is adequately mitigated. Where that would not be done adequately, defects in the material may be cause for rejection of products; for example, rigid packages such as plastic bottles may become too brittle and thereby lead to leakages; flexible packages such as plastic films and sheets may demonstrate undesirable discoloration; and degradation of the polymer material may lead to molecular weight change and as a consequence thereof an altered melt flow, which may negatively impact manufacturing processes of products comprising such polymers.

Accordingly, there is a need for these effects to be mitigated.

### SUMMARY

The present invention relates thereto, by providing a polyethylene composition comprising:
at least one of
(a) a first ethylene-based polymer or a composition comprising a first ethylene-based polymer; and
(b) a second ethylene-based polymer;
and
(c) ≥100 and ≤5000 ppm, preferably ≥500 and ≤2500 ppm, of 2,2-bis(hydroxymethyl)-1,2-propanediol, with regard to the total weight of the polyethylene composition.

### DETAILED DESCRIPTION

For example, the polyethylene composition may comprise:
(a) a first ethylene-based polymer or a composition comprising a first ethylene-based polymer; and
(b) a second ethylene-based polymer;
and
(c) ≥100 and ≤5000 ppm, preferably ≥500 and ≤2500 ppm, of 2,2-bis(hydroxymethyl)-1,2-propanediol, with regard to the total weight of the polyethylene composition.

For example, the polyethylene composition may comprise: at least one of
(a) a first ethylene-based polymer and
(b) a second ethylene-based polymer;
and
(c) ≥100 and ≤5000 ppm, preferably ≥500 and ≤2500 ppm, of 2,2-bis(hydroxymethyl)-1,2-propanediol, with regard to the total weight of the polyethylene composition.

It is preferred that the second ethylene-based polymer is different from the first ethylene-based polymer.

Each of the first and the second ethylene-based polymer may individually be a homopolymer of ethylene or a copolymer of ethylene and an α-olefin comprising 3-8 carbon atoms. The α-olefin comprising 3-8 carbon atoms may for example be selected from 1-propene, 1-butene, 1-pentene, 1-hexene, 4-methyl-1-pentene, and 1-octene. Preferably, the α-olefin comprising 3-8 carbon atoms is selected from 1-butene, 1-hexene and 1-octene.

It is preferred that each of the first and the second ethylene-based polymer comprises ≥ 60.0 wt, preferably ≥80.0 wt %, more preferable ≥90.0 wt %, even more preferably ≥95.0 wt % of moieties derived from ethylene, with regard to the total weight of the ethylene-based polymer.

It is further also preferred that the polyethylene composition comprises ≥70.0 wt %, preferably ≥80.0 wt %, more preferably ≥90.0 wt %, even more preferably ≥95.0 wt %, yet even more preferably >98.0 wt %, of ethylene-based polymers. The total quantity of the ethylene-based polymers in the polyethylene composition may for example consist of the sum of the first ethylene-based polymer and the second ethylene-based polymer.

The first ethylene-based polymer may for example be a post-consumer recyclate (PCR). The PCR may for example be a high-density polyethylene having a density of ≥940 and ≤975 kg/m³, as determined in accordance with ASTM D792 (2008). Alternatively, the PCR may be a composition comprising high-density polyethylene and ≥0.1 and ≤5.0 wt % of polypropylene, preferably >0.1 and ≤2.0 wt %, with regard to the total weight of the PCR, and having a density of ≥940 and ≤975 kg/m³, as determined in accordance with ASTM D792 (2008).

For example, the PCR may be a composition comprising:
high-density polyethylene having a density of ≥940 and ≤975 kg/m³, as determined in accordance with ASTM D792 (2008) and
>0.1 and ≤5.0 wt % of polypropylene, preferably ≥0.1 and ≤2.0 wt %, with regard to the total weight of the PCR,
   the PCR having a density of >940 and ≤975 kg/m³, as determined in accordance with ASTM D792 (2008).

For example, the PCR may be a composition comprising:
≥75.0 and ≤99.9 wt %, preferably ≥80.0 and ≤98.0 wt %, more preferably ≥90.0 and ≤ 98.0 wt %, of high-density polyethylene having a density of ≥940 and ≤975 kg/m3, as determined in accordance with ASTM D792 (2008) and
≥0.1 and ≤5.0 wt % of polypropylene, preferably >0.1 and ≤2.0 wt %, with regard to the total weight of the PCR,
   the PCR having a density of >940 and ≤975 kg/m³, as determined in accordance with ASTM

D792 (2008).

The first ethylene-based polymer may for example be:
(i) a low-density polyethylene (LDPE) produced via free radical polymerisation, having a density of ≥905 and ≤935 kg/m², preferably ≥910 and ≤925 kg/m²;
(ii) a linear low-density polyethylene (LLDPE) having a density of ≥870 and <940 kg/m³, preferably ≥900 and ≤925 kg/m³; or
(iii) a high-density polyethylene (HDPE) having a density of ≥940 and ≤975 kg/m³, preferably ≥945 and ≤965 kg/m³
   wherein the density is determined in accordance with ASTM D792 (2008).

The second ethylene-based polymer may for example be:
(i) a low-density polyethylene (LDPE) produced via free radical polymerisation, having a density of ≥905 and ≤935 kg/m²;
(ii) a linear low-density polyethylene (LLDPE) having a density of ≥870 and <940 kg/m³; or
(iii) a high-density polyethylene (HDPE) having a density of ≥940 and ≤975 kg/m³
   wherein the density is determined in accordance with ASTM D792 (2008).

The skilled person will understand that, even though there may be an overlapping range of the definition of the density, an LDPE polyethylene intrinsically differs from an LLDPE polyethylene. An LLDPE according to the present invention may be an ethylene-based polymer produced via a catalytic polymerisation process, such as a Ziegler-catalysed ethylene polymerisation process, or an ethylene polymerisation process catalysed using single-site catalysts. A particular example of a category of suitable single-site catalysts is the category of metallocene catalysts. Catalytic ethylene polymerisation to produce LLDPE typically occurs as a pressure of up to 20 MPa, particularly between 5.0 and 15.0 MPa.

An LDPE is to be understood as an ethylene-based polymer produced via high-pressure polymerisation. High-pressure polymerisation herein is to be understood as polymerisation at pressures of 100 MPa or above, such as between 100 MPa and 300 MPa, particularly between 200 MPa and 300 MPa.

The first ethylene-based polymer may for example have a melt mass-flow rate as determined in accordance with ISO 1133 (2011) at 190° C. under a load of 21.6 kg (MFR21) of ≥5.0 and ≤200.0 g/10 min, preferably of ≥10.0 and ≤100.0 g/10 min, more preferably of ≥20.0 and ≤50.0 g/10 min. The first ethylene-based polymer may for example have a melt mass-flow rate as determined in accordance with ISO 1133 (2011) at 190° C. under a load of 2.16 kg

(MFR21) of ≥0.1 and ≤50.0 g/10 min, preferably of ≥0.1 and ≤10.0 g/10 min, more preferably of >0.3 and ≤2.5 g/10 min. The first ethylene-based polymer may for example have a melt mass-flow rate as determined in accordance with ISO 1133 (2011) at 190° C. under a load of 5.0 kg (MFR21) of ≥0.1 and ≤50.0 g/10 min, preferably of ≥0.5 and ≤25.0 g/10 min, more preferably of ≥1.0 and ≤10.0 g/10 min.

The invention also relates to an article comprising the polymer composition according to the invention, preferably wherein the article is a blow-moulded bottle or container.

In a further embodiment, the invention also relates to the use of 2,2-bis (hydroxymethyl)-1,2-propanediol, preferably ≥100 and ≤5000 ppm, more preferably of ≥500 and ≤2500 ppm, of 2,2-bis (hydroxymethyl)-1,2-propanediol, for reduction of the yellowness index of a polyethylene composition comprising a post-consumer recyclate (PCR), preferably wherein the PCR is a high-density polyethylene having a density of ≥940 and ≤975 kg/m³, as determined in accordance with ASTM D792 (2008).

In a further embodiment, the invention also relates to the use of 2,2-bis (hydroxymethyl)-1,2-propanediol, preferably ≥100 and ≤5000 ppm, more preferably ≥500 and ≤2500 ppm, of 2,2-bis (hydroxymethyl)-1,2-propanediol, for reduction of the yellowness index of a polyethylene composition comprising a post-consumer recyclate (PCR), preferably:
wherein the PCR is a high-density polyethylene having a density of ≥940 and ≤975 kg/m³, as determined in accordance with ASTM D792 (2008), or
wherein the PCR is a composition comprising high-density polyethylene and ≥0.1 and ≤5.0 wt % of polypropylene, preferably ≥0.1 and ≤2.0 wt %, with regard to the total weight of the PCR, and having a density of ≥940 and ≤975 kg/m³, as determined in accordance with ASTM D792 (2008).

In a further embodiment, the invention also relates to the use of 2,2-bis (hydroxymethyl)-1,2-propanediol, preferably ≥100 and ≤5000 ppm, more preferably ≥500 and ≤2500 ppm, of 2,2-bis (hydroxymethyl)-1,2-propanediol, for improvement of the oxidation induction time of a polyethylene composition comprising a post-consumer recyclate (PCR), preferably:
wherein the PCR is a high-density polyethylene having a density of ≥940 and ≤975 kg/m³, as determined in accordance with ASTM D792 (2008), or
wherein the PCR is a composition comprising high-density polyethylene and ≥0.1 and ≤5.0 wt % of polypropylene, preferably >0.1 and ≤2.0 wt %, with regard to the total weight of the PCR, and having a density of ≥940 and ≤975 kg/m³, as determined in accordance with ASTM D792 (2008).

In post-consumer recycling waste thermoplastic polymer materials, also referred to herein as PCR materials, the quantity of additives that remain present in their functional appearance typically is significantly decreased when compared to the quantity that was present in the polymer materials as originally used to manufacture the object that now is subject to recycling. Furthermore, during the service life of the object, exposure to conditions of use and environment tend to lead to certain degradation of the polymer material. Accordingly, the quality of the polymer that is subjected to recycling is commonly to a certain extent inferior to that of the polymer as originally obtained from the polymerisation plant, which may also be referred to herein as the virgin polymer.

In recycling of such PCR material, a typical process that is desirably employed is melt processing. In such processes, the PCR material is heated to above its melting temperature, allowing the thermoplastic material to be melt-shaped into a new object as required. Such melt processing in most instances takes place in melt extrusion or injection moulding machinery. During such process, the material will be subject to high temperature as well as to a certain amount of shear. As a result thereof, the already aged polymer material is further subjected to influences that detrimentally affect its quality.

It is therefore paramount that alleviating measures are implemented in order to prevent such quality decrease to be of a nature that producing an object of required quality is not possible.

The invention will now be illustrated by the following non-limiting examples.

Materials:

| | |
|---|---|
| HDPE | SABIC B6246LS, a high-density polyethylene grade having a density of |
| | 961 kg/m³, obtainable from SABIC |
| PCR1 | Post-consumer recyclate polyethylene composition having a density of |
| | 963 kg/m³, comprising 1053 ppm Ti and 2.0 wt % polypropylene |
| PCR2 | Post-consumer recyclate polyethylene composition having a density of |
| | 957 kg/m³, comprising 47 ppm Ti and 0.3 wt % polypropylene |
| PCR3 | Post-consumer recyclate polyethylene composition having a density of |
| | 969 kg/m³, comprising 7350 ppm Ti and 1.4 wt % polypropylene |
| AO1 | 2,2-bis(hydroxymethyl)-1,2-propanediol, CAS reg. nr. 115-77-5 |
| AO2 | d-mannitol, CAS reg. nr. 69-65-8 |
| AO3 | Dibenzyl hydroxylamine, CAS reg. nr. 621-07-8 |
| Irgafos 168 | (2,4-bis(t-butyl))-1,1′,1″-phosphite phenol, CAS reg. nr. 31570-04-4 |
| Irganox 1010 | Benzenepropanoic acid, 3,5-bis(1,1-dimethylethyl)-4-hydroxy-,1,1′-[2,2- |
| | bis[[3-[3,5-bis(1,1-dimethylethyl)-4-hydroxyphenyl]-1-oxopropoxy]methyl]- |
| | 1,3-propanediyl] ester, CAS reg. nr. 6683-19-8 |
| Irganox MD | Benzenepropanoic acid, 3,5-bis(1,1-dimethylethyl)-4-hydroxy-,2-[3-[3,5- |
| 1024 | bis(1,1-dimethylethyl)-4-hydroxyphenyl]-1-oxopropyl]hydrazide, CAS reg. |
| | nr. 32687-78-8 |
| CaSt | Calcium stearate, CAS reg. nr. 1592-23-0 |

The HDPE and PCR materials contained the below formulations of additives (in ppm):

| | HDPE | PCR1 | PCR2 | PCR3 |
|---|---|---|---|---|
| Irgafos 168 | 1000 | 292.6 | 227 | 141 |
| Irganox 1010 | 500 | 145 | 140 | 194 |
| Irganox MD 1024 | 200 | 59.5 | 27 | 20 |
| CaSt | 1000 | 223 | 67 | 349 |

Using the above materials, a number of polymer compositions were prepared via melt extrusion. The melt extrusion was performed according to the following protocol. The melt extrusion processing was performed using a Werner & Pfleiderer ZSK-25 co-rotating twin-screw melt extruder having a screw diameter of 25 mm, an L/D ratio of 40, operated at 250 rpm, having a set temperature profile along the extruder zones of:

| L1 | L2 | L3 | L4 | L5 | L6 | L7 | L8 | L9 | L10 |
|---|---|---|---|---|---|---|---|---|---|
| 150° C. | 190° C. | 200° C. | 210° C. | 210° C. | 210° C. | 220° C. | 220° C. | 220° C. | 220° C. |

wherein zone L1 is the zone wherein the polymer material is fed to the extruder, and zone L10 is the zone wherein the material is extruded from the extruder. The extruder screws were configured to contain shear-inducing blocks.

According to the above-presented extruder conditions, polymer formulations were extruded having a composition according to the tables below. The values in the tables reflect the composition of the formulations as supplied to the extrusion process, wherein contents of each ingredient are indicated in ppm or wt % with regard to the total weight of the polymer formulation.

| Example | 1A | 2A | 3A | 4A | 5A | 6A | 7A | 8A |
|---|---|---|---|---|---|---|---|---|
| HDPE (wt %) | 99.73 | 99.63 | 99.63 | | | 50.00 | 49.88 | 49.83 |
| PCR1 (wt %) | | | | 100.00 | 99.80 | 50.00 | 49.88 | 49.83 |
| PCR2 (wt %) | | | | | | | | |
| PCR3 (wt %) | | | | | | | | |
| AO1 (ppm) | | | 1000 | | | | | |
| AO2 (ppm) | | 1000 | | | | | | 1000 |
| AO3 (ppm) | | | | | | | | |
| Irgafos 168 (ppm) | 1000 | 1000 | 1000 | | 707.4 | | 853.7 | 853.7 |
| Irganox 1010 (ppm) | 500 | 500 | 500 | | 354.7 | | 427.35 | 427.35 |
| Irganox MD1024 (ppm) | 200 | 200 | 200 | | 140.5 | | 170.25 | 170.25 |
| CaSt (ppm) | 1000 | 1000 | 1000 | | 777 | | 888.5 | 888.5 |

| Example | 9A | 10A | 11A | 12A | 13A | 14A | 15A | 16A |
|---|---|---|---|---|---|---|---|---|
| HDPE (wt %) | 49.83 | | | 50.00 | 49.87 | 49.82 | 49.82 | |
| PCR1 (wt %) | 49.83 | | | | | | | |
| PCR2 (wt %) | | 100.00 | 99.77 | 50.00 | 49.87 | 49.82 | 49.82 | |
| PCR3 (wt %) | | | | | | | | 100.00 |
| AO1 (ppm) | 1000 | | | | | | 1000 | |
| AO2 (ppm) | | | | | | 1000 | | |
| AO3 (ppm) | | | | | | | | |
| Irgafos 168 (ppm) | 853.7 | | 773 | | 886.5 | 886.5 | 886.5 | |
| Irganox 1010 (ppm) | 427.35 | | 360 | | 430 | 430 | 430 | |
| Irganox MD1024 (ppm) | 170.25 | | 174 | | 187 | 187 | 187 | |
| CaSt (ppm) | 888.5 | | 933 | | 966.5 | 966.5 | 966.5 | |

| Example | 17A | 18A | 19A | 20A | 21A | 22A | 23A |
|---|---|---|---|---|---|---|---|
| HDPE (wt %) | | 50.00 | 49.88 | 49.83 | 49.83 | 49.82 | 49.83 |
| PCR1 (wt %) | | | | | | | |
| PCR2 (wt %) | | | | | | | |
| PCR3 (wt %) | 99.80 | 50.00 | 49.88 | 49.83 | 49.83 | 49.82 | 49.8 |
| AO1 (ppm) | | | | | 1000 | | |
| AO2 (ppm) | | | | 1000 | | | |
| AO3 (ppm) | | | | | | 1000 | 1000 |
| Irgafos 168 (ppm) | 859 | | 929.5 | 929.5 | 929.5 | 886.5 | 929.5 |
| Irganox 1010 (ppm) | 306 | | 403 | 403 | 403 | 430 | 403 |
| Irganox MD 1024 (ppm) | 180 | | 190 | 190 | 190 | 187 | 190 |
| CaSt (ppm) | 651 | | 825.5 | 825.5 | 825.5 | 966.5 | 825.5 |

The total content of the additives, including those already present in the PCR1, PCR2 or PCR3 samples and those introduced in the extrusion process as described above is presented in the tables below.

| Example | 1A | 2A | 3A | 4A | 5A | 6A | 7A | 8A |
|---|---|---|---|---|---|---|---|---|
| AO1 (ppm) | | | 1000 | | | | | |
| AO2 (ppm) | | 1000 | | | | | | 1000 |
| AO3 (ppm) | | | | | | | | |
| Irgafos 168 (ppm) | 1000 | 1000 | 1000 | 292.6 | 1000 | 146.3 | 1000 | 1000 |
| Irganox 1010 (ppm) | 500 | 500 | 500 | 145.3 | 500 | 72.65 | 500 | 500 |
| Irganox MD1024 (ppm) | 200 | 200 | 200 | 59.5 | 200 | 29.75 | 200 | 200 |
| CaSt (ppm) | 1000 | 1000 | 1000 | 223 | 1000 | 111.5 | 1000 | 1000 |

| Example | 9A | 10A | 11A | 12A | 13A | 14A | 15A | 16A |
|---|---|---|---|---|---|---|---|---|
| AO1 (ppm) | 1000 | | | | | | 1000 | |
| AO2 (ppm) | | | | | | 1000 | | |
| AO3 (pmm) | | | | | | | | |
| Irgafos 168 (ppm) | 1000 | 227 | 1000 | 113.5 | 1000 | 1000 | 1000 | 141 |
| Irganox 1010 (ppm) | 500 | 140 | 500 | 500 | 500 | 500 | 500 | 194 |
| Irganox MD1024 (ppm) | 200 | 26 | 200 | 13 | 200 | 200 | 200 | 20 |
| CaSt (ppm) | 1000 | 67 | 1000 | 33.5 | 1000 | 1000 | 1000 | 349 |

| Example | 17A | 18A | 19A | 20A | 21A | 22A | 23A |
|---|---|---|---|---|---|---|---|
| AO1 (ppm) | | | | | 1000 | | |
| AO2 (ppm) | | | | 1000 | | | |
| AO3 (pmm) | | | | | | 1000 | 1000 |
| Irgafos 168 (ppm) | 1000 | 70.5 | 1000 | 1000 | 1000 | 1000 | 1000 |
| Irganox 1010 (ppm) | 500 | 97 | 500 | 500 | 500 | 500 | 500 |
| Irganox MD 1024 (ppm) | 200 | 10 | 200 | 200 | 200 | 200 | 200 |
| CaSt (ppm) | 1000 | 174.5 | 1000 | 1000 | 1000 | 1000 | 1000 |

Using the formulations 1A-23A as obtained from melt extrusion processing like described above, the melt mass-flow rate at 21.6 kg/190° C. (MFR21), the oxidation induction time (OIT) and the yellowness index (YI) were determined. The obtained values constitute the first-pass properties.

Furthermore, a quantity of material of each example was once further subjected to melt extrusion according to the process conditions as indicated above, thus a second-pass extrusion of the materials was performed. Of the thus obtained second-pass examples 1B-21B, the MFR21, OIT and YI were again determined.

Finally, a quantity of material of each example 1B-23B was again subjected to melt extrusion according to the process conditions as indicated above, thus a third-pass extrusion of the materials was performed. Of the thus obtained third-pass examples 1C-23C, the MFR21, OIT and Yl were again determined.

By this repeated thermal exposure, the retention of properties upon exposure was tested. Results of the testing of MFR21, YI and OIT are presented in the table below.

| | OIT | | | YI | | | MFR21 | | |
|---|---|---|---|---|---|---|---|---|---|
| Example | A | B | C | A | B | C | A | B | C |
| 1 | 83 | 78 | 64 | −1 | 1 | 4 | 42 | 46 | 40 |
| 2 | 76 | 94 | 83 | 13 | 17 | 18 | 41 | 47 | 40 |
| 3 | 92 | 88 | 83 | 1 | 2 | 3 | 48 | 48 | 48 |
| 4 | 39 | 8 | 8 | 7 | 7 | 7 | 37 | 36 | 36 |
| 5 | 65 | 44 | 37 | 3 | 5 | 6 | 43 | 43 | 44 |
| 6 | 5 | 6 | 6 | 4 | 5 | 5 | 44 | 42 | 42 |
| 7 | 64 | 40 | 30 | 3 | 6 | 6 | 46 | 43 | 46 |
| 8 | 88 | 89 | 85 | 9 | 10 | 10 | 41 | 40 | 40 |
| 9 | 67 | 60 | 51 | 4 | 4 | 3 | 42 | 50 | 49 |
| 10 | 10 | 9 | 8 | 17 | 18 | 18 | 27 | 27 | 27 |
| 11 | 41 | 44 | 20 | 18 | 19 | 19 | 29 | 29 | 30 |
| 12 | 4 | 3 | 4 | 12 | 12 | 12 | 33 | 32 | 30 |
| 13 | 52 | 38 | 25 | 13 | 14 | 16 | 36 | 37 | 35 |
| 14 | 84 | 74 | 78 | 14 | 16 | 18 | 34 | 37 | 37 |
| 15 | 72 | 62 | 73 | 11 | 11 | 12 | 37 | 38 | 41 |
| 16 | 10 | 9 | 8 | 9 | 9 | 9 | 25 | 27 | 27 |
| 17 | 14 | 22 | 23 | 9 | 9 | 10 | 26 | 28 | 29 |
| 18 | 3 | 3 | 3 | 8 | 9 | 9 | 32 | 31 | 32 |
| 19 | 55 | 18 | 20 | 9 | 10 | 11 | 35 | 37 | 34 |
| 20 | 72 | 58 | 49 | 9 | 10 | 11 | 32 | 37 | 35 |
| 21 | 74 | 69 | 56 | 8 | 9 | 8 | 37 | 38 | 40 |
| 22 | 40 | 31 | 28 | 14 | 16 | 17 | 38 | 37 | 42 |
| 23 | 39 | 35 | 41 | 9 | 10 | 11 | 37 | 33 | 41 |

The oxidation induction time (OIT) was determined in accordance with ISO 11357-6 (2018), using air, at a temperature of 210° C. The melt-mass flow rate (MFR21) was determined in accordance with ISO 1133 (2011), under a load of 21.6 kg at a temperature of 190° C. The yellowness index (YI) was determined in accordance with ASTM E313 (2015).

From the above, it can be observed that addition of AO1, the 2,2-bis (hydroxymethyl)-1,2-propanediol, results in high retention or even improvement of OIT and reduction of the yellowness index YI, i.e. a lesser yellow coloration of the product, which is particularly desirable, especially in processing post-consumer recyclate materials.

1. Polyethylene composition comprising:
at least one of
(a) a first ethylene-based polymer or a composition comprising a first ethylene-based polymer; and
(b) a second ethylene-based polymer;
and (c) ≥100 and ≤5000 ppm, of 2,2-bis(hydroxymethyl)-1,2-propanediol, with regard to the total weight of the polyethylene composition.

2. Polyethylene composition according to claim 1, wherein the second ethylene-based polymer is different from the first ethylene-based polymer.

3. Polyethylene composition according to claim 1, wherein each of the first and the second ethylene-based polymer individually is a homopolymer of ethylene or a copolymer of ethylene and an α-olefin comprising 3-8 carbon atoms.

4. Polyethylene composition according to claim 3, wherein the α-olefin comprising 3-8 carbon atoms is selected from 1-propene, 1-butene, 1-pentene, 1-hexene, 4-methyl-1-pentene, and 1-octene.

5. Polyethylene composition according to any claim 1, wherein each of the first and the second ethylene-based polymer comprises ≥60.0 wt, of moieties derived from ethylene, with regard to the total weight of the ethylene-based polymer.

6. Polyethylene composition according to claim 1, wherein the composition comprises ≥70.0 wt %, of ethylene-based polymers.

7. Polymer composition according to claim 6, wherein the total quantity of the ethylene-based polymers consist of the sum of the first ethylene-based polymer and the second ethylene-based polymer.

8. Polymer composition according to claim 1, wherein the first ethylene-based polymer or the composition comprising the first ethylene-based polymer is a post-consumer recyclate, (PCR).

9. Polymer composition according to claim 1, wherein the first ethylene-based polymer is:
(i) a low-density polyethylene (LDPE) produced via free radical polymerisation, having a density of ≥905 and ≤935 kg/m²;
(ii) a linear low-density polyethylene (LLDPE) having a density of ≥870 and <940 kg/m³; or
(iii) a high-density polyethylene (HDPE) having a density of ≥940 and ≤975 kg/m³ wherein the density is determined in accordance with ASTM D792 (2008).

10. Polymer composition according to claim 1, wherein the second ethylene-based polymer is:
(i) a low-density polyethylene (LDPE) produced via free radical polymerisation, having a density of >905 and ≤935 kg/m²;
(ii) a linear low-density polyethylene (LLDPE) having a density of ≥870 and <940 kg/m³; or
(iii) a high-density polyethylene (HDPE) having a density of ≥940 and ≤975 kg/m³ wherein the density is determined in accordance with ASTM D792 (2008).

11. Polymer composition according to claim 1, wherein the first ethylene-based polymer has a melt mass-flow rate as determined in accordance with ISO 1133 (2011) at 190° C. under a load of 21.6 kg (MFR21) of ≥5.0 and ≤200.0 g/10 min.

12. Polymer composition according to claim 1, wherein the second ethylene-based polymer has a melt mass-flow rate as determined in accordance with ISO 1133 (2011) at 190° C. under a load of 21.6 kg (MFR21) of ≥5.0 and ≤200.0 g/10 min.

13. Article comprising the polymer composition according to claim 1.

14. A method for reduction of the yellowness index of a polyethylene composition comprising a post-consumer recyclate (PCR), the method comprising combinig 2,2-bis(hydromethyl)-1,2-propanediol with the PCR,
wherein the PCR is a high-density polyethylene having a density of ≥940 and ≤975 kg/m³, as determined in accordance with ASTM D792 (2008), or
wherein the PCR is a composition comprising high-density polyethylene and ≥0.1 and ≤5.0 wt % of polypropylene, with regard to the total weight of the PCR, and having a density of >940 and ≤975 kg/m³, as determined in accordance with ASTM D792 (2008).

15. A method for improvement of the oxidation induction time of a polyethylene composition comprising a post-consumer recyclate (PCR), the method comprising combining 2,2-bis(hydromethyl)1,2-propanediol with the PCR,
wherein the PCR is a high-density polyethylene having a density of ≥940 and ≤ 975 kg/m³, as determined in accordance with ASTM D792 (2008), or
wherein the PCR is a composition comprising high-density polyethylene and ≥ 0.1 and ≤5.0 wt % of polypropylene, with regard to the total weight of the PCR, and having a density of ≥940 and ≤975 kg/m³, as determined in accordance with ASTM D792 (2008).

16. Polymer composition according to claim 8,
wherein the PCR is a high-density polyethylene having a density of ≥940 and ≤975 kg/m³, as determined in accordance with ASTM D792 (2008), or
wherein the PCR is a composition comprising high-density polyethylene and >0.1 and ≤5.0 wt % of polypropylene, preferably >0.1 and ≤2.0 wt %, with regard to the total weight of the PCR, and having a density of ≥940 and ≤975 kg/m³, as determined in accordance with ASTM D792 (2008).
